(19) United States
(12) Patent Application Publication
(10) Pub. No.: US 2003/0151768 A1
(43) Pub. Date: Aug. 14, 2003

(54) Public print system, public print service providing method, recording medium, and program

(76) Inventor: Mitsunori Iida, Tokyo (JP)

Correspondence Address: ROBIN BLECKER & DALEY, 2ND FLOOR, 330 MADISON AVENUE, NEW YORK, NY, 10017, US

(21) Appl. No.: 10/361,381

(22) Filed: Feb. 10, 2003

(30) Foreign Application Priority Data
Feb. 14, 2002 (JP) 037375/2002
Feb. 14, 2002 (JP) 037376/2002

(51) Int. Cl. B41J 1/00; G06F 15/00

(52) U.S. Cl. 358/1.15

(57) ABSTRACT

Disclosed is a technique which provides a public print system and public print service providing method each of which is based on the use of electronic watermarks embedded in the digital contents. The technique has a data output control device that includes means for generating output data, means for extracting the contents, means for transferring the output data and the extracted contents to a processing device that performs print-fee-charging calculation with respect to those output data and extracted contents that are set to fall under the category of a print job, and means for attaining fee charging information from the processing device performing fee-charging calculation and displays it. The technique also has a fee payment processing device that includes means for extracting from the extracted contents the information that has been embedded therein as electronic watermarks, means for, according to the information that has been embedded, in a case where the information meets predetermined requirements, performing prescribed discounting with respect to the fee that is charged on the printing of the information containing digital contents, and means for performing actual fee payment for the printing according to the discounting information by subtracting the discounting amount.

### BACKGROUND OF THE INVENTION

1. Field of the Invention

This invention relates to a public print system that performs printing of information containing therein digital contents on a basis that is charged a fee and a public print service providing method using the system.

2. Related Background Art

As a typical output device for outputting information containing therein digital contents, there is a printer. A printer driver that is data output control unit for controlling the output will now be explained. The term “digital contents” that is referred to in the following description indicates moving images, static images, voices, computer programs, computer data, etc. The term “information containing digital contents therein” indicates information that has data, such as letters and graphics, together with digital contents.

Generally, in a computer having connected thereto a printer, a printer driver for controlling the printer is installed. When performing printing, in the computer, image data which has been produced by an application installed therein and that includes letters, figures, natural picture images, etc. is supplied to the printer driver as print information. In the printer driver, it produces print data, which can be print-processed by the printer, according to the print information that has been supplied. It then transfers that print data to the printer.

Concretely, in the printer driver, it executes a processing method of analyzing print information that has been transmitted from the application, binarizing image data contained in the print information in accordance with a prescribed procedure, and developing (rasterizing) that binary data into a band memory, and thereby producing print data, or a processing method of analyzing print information that has been transmitted from the application, converting image data contained in the print information into multi-valued data, and developing (rasterizing) that multi-valued data into a band memory, and, while this developed data is being binarized in units of a raster line in accordance with a prescribed procedure, producing print data, or a method of analyzing print information that has been transmitted from the application, to thereby produce a printer control language (the so-called “PDL”) that the printer can understand.

As the above-described procedure of binarizing, there is used one of the procedure using a pattern dither, an error diffusion procedure, etc. The procedure using a pattern dither is the one which can perform high-speed and uniform binarization. This procedure suits binarization of letters, figures, etc. In contrast to this, the error diffusion procedure is the one which can express fine gradation the color of that finely changes in very small stages and this procedure suits binarization of a natural picture image, or the like.

Next, an explanation will be explained of electronic digital watermarks. Digital information has the feature of, in comparison with conventional analog information, being simply copied and modified by a computer, etc. and being easy to transfer through the intermediary of a communication line. Owing to that feature, digital information has tended to be unjustly easily copied and re-distributed. As one of the method for preventing that, there is a method of embedding electronic watermarks. Electronic watermarks means information that is embedded in the digital contents and that cannot be looked at, or recognized, with the human eyes. Even when reproducing the digital contents having embedded therein electronic watermarks using an ordinary method, it is impossible to perceive them.

Taking up a digital image as an example, as a typical one of the electronic-watermark embedding method, there is a method of performing calculation with respect to the data values of digital contents that fall upon the hue, brightness, etc. of the pixels and embedding the electronic watermarks. As a method that is typical of the method, there is a technique that is disclosed in U.S. Pat. No. 5,636,292 of Digimarc Company and that has the steps of dividing digital contents into blocks and adding, every block, into the block, a predetermined watermark pattern that is a combination of (+1) and (−1).

As another method of embedding electronic watermarks, there is a procedural technique including the steps of performing frequency conversion with respect to digital contents by performing high-speed Fourier transform, discrete cosine transform, or Wavelet transform with respect thereto, thereby adding watermark information to the relevant frequency range, thereafter performing inverse frequency conversion with respect to the resulting digital contents, and thereby embedding the watermarks.

In the above-described procedural technique using a high-speed Fourier transform, the input contents are diffused by having added thereto a PN list and then are divided into blocks. With respect to the data, Fourier transform is performed every block, thereby a 1 bit of watermark information is embedded into one block. The block with respect to that watermark information has been embedded is subjected to inverse Fourier transform. The same PN list as that which was initially added is then added again, thereby the contents having electronic watermarks embedded therein are obtained. Refer to “Method of Signing an Image by Using a PN List” by Ohnishi, Oka, and Matsui for more detail.

In the above-described procedural technique of embedding electronic watermarks by performing discrete cosine transform, the input contents are divided into blocks and discrete cosine transform is performed every block. A 1 bit of information is embedded into a 1 block. Thereafter, inverse transform is performed with respect to that block to thereby produce contents having embedded therein electronic watermarks. Refer to “Method of Making Electronic Watermarks in Frequency Range for Protection of the Copyright of Digital Images” by Nakamura, Ogawa, and Takashima, 1997, a collection of code and information security symposium public lecture theses, SCIS′97-27A, for more detail.

The above-described procedural technique based on performing Wavelet transform is the one wherein dividing the input contents into blocks is not needed. Refer to “Experimental Study on the Security and Reliability of Electronic Watermark Making Technique based on the Use of Wavelet Transform” by Ishizuka, Sakai, and Sakurai, 1997, a collection of code and information security symposium public lecture theses, SCIS′97-26D, for more detail.

As typical one of the information that is embedded into the digital contents as electronic watermarks through the execution of the above-described respective procedural technique, copyright information and user information can be taken up as an example. By embedding copyright information, the user can know that the copyright is set in the digital contents, who the copyright owner is, etc.

Also, embedding user information enables to provide various kinds of user services in which the user information is active. However, in the conventional public print or public print service providing method, sufficient consideration has not been given of how to utilize information that has been embedded as electronic watermarks.

As has been explained in the above-described example, in the conventional public print system or public print service offering method, no consideration has been given of the utilization of the information that has been embedded as electronic watermarks.

### SUMMARY OF THE INVENTION

The invention has been made in order to solve the above-described problems and has an object to facilitate the promotion toward the respective users of the public print system or public print service offering method by utilizing information that has been embedded as electronic watermarks.

In order to achieve the above object, in a data output control device of a public print system according to an embodiment of the present invention, there are provided generating means for generating from information containing digital contents output data that an output device provided in a shop can output, extracting means for extracting those of the digital contents which can contain electronic watermarks, transferring means for transferring the output data and the extracted contents that have been extracted to a processing device that performs print-fee-charging calculation with respect to those output data and extracted contents, and displaying means for attaining charged fee information from the processing device performing fee-charging calculation and displays it. Also, in a fee payment processing device of a public print system according to the present invention, there are provided extracting means for extracting from the extracted digital contents the information that has been embedded therein, fee charging means for, according to the embedded information that has been extracted, in a case where the information meets predetermined requirements, performing prescribed discounting with respect to the fee that is charged on the printing of the information containing digital contents, and payment means for performing actual fee payment for the printing according to the discounting information by subtracting the discounting amount.

Also, in the output device of the public print system according to the embodiment of the present invention, embedded information is attained from the output data and digital contents generated in the data output control device and fee charge calculation intended for discounting the price is executed, print processing is executed, and fee payment processing is executed, all together.

Also, in the data output control device in the public print system according to the present invention, there is provided means for setting an upper limit with respect to a discounting amount of money when performing fee charge calculation including discounting operations, according to the embedded information in the digital contents, and determining the discounting amount of money as being the one that corresponds to the upper limit when the discounting amount of money has exceeded the upper limit.

Also, the public print service providing method according to the present invention includes a data output control method comprising the steps of: generating from information containing digital contents output data that an output device provided in a shop can output; extracting those of the digital contents which can contain electronic watermarks; transferring the output data and the extracted digital contents to a processing device that performs print-fee-charging calculation with respect to those output data and extracted; and attaining charged fee information from the processing device performing fee-charging calculation and displaying it, and a fee payment processing method comprising the steps of: extracting from the extracted digital contents the information that has been embedded therein; according to the extracted information that has been embedded, in a case where the information meets predetermined requirements, performing prescribed discounting with respect to the fee that is charged on the printing of the information containing digital contents; and performing actual fee payment for the printing according to the discounting information by subtracting the discounting amount.

Also, the public print service providing method according to the embodiment of the present invention further comprises the step of attaining embedded information from the output data and digital contents that have been produced in the data output controlling device and executing fee charging calculation intended for discounting the price, executing print processing, and fee payment processing, all together.

Further, the public print service providing method according to the embodiment of the present invention further comprises the step of setting an upper limit with respect to a discounting amount of money when performing fee charging calculation including discounting operations, according to the embedded information in the digital contents and, determining the discounting amount of money as being the one that corresponds to the upper limit when the discounting amount of money has exceeded the upper limit.

### BRIEF DESCRIPTION OF THE DRAWINGS

FIG. 1 is a block diagram illustrating a schematic construction of a public print system according to an embodiment of the present invention;

FIG. 2 is a block diagram illustrating a construction of a computer terminal that constitutes a part of the public print system according to the embodiment of the present invention;

FIG. 3 is a flow chart illustrating a processing flow that represents the embodiment of the present invention;

FIG. 4 is a flow chart illustrating a processing flow that represents a print job generation process according to the embodiment of the present invention;

FIG. 5 is a view illustrating the construction of a print job that is produced by a printer driver according to the embodiment of the present invention;

FIG. 6 is a view illustrating an example of information including digital contents according to the embodiment of the present invention;

FIG. 7 is a view illustrating an example of print job attributes illustrated in FIG. 5 according to the embodiment of the present invention;

FIG. 8 is a view illustrating an example of a user interface for confirmation of the print job fee in the embodiment of the present invention;

FIG. 9 is a view illustrating an example of a method of selecting a printer driver from an application driver according to the embodiment of the present invention;

FIG. 10 is a view illustrating an example of the attribute information that is produced by extracting electronic watermark information according to the embodiment of the present invention;

FIG. 11 is a view illustrating the kind of the electronic watermarks and discount rate information of the print fees, which correspond thereto, according to the embodiment of the present invention;

FIG. 12 is a view illustrating information that is necessary for calculation of charged fee information according to the embodiment of the present invention;

FIG. 13 is a view illustrating an example of charged fee information according to another embodiment of the present invention;

FIG. 14 is a block diagram illustrating a schematic construction of the public print system according to another embodiment of the present invention;

FIG. 15 is a view illustrating an example, in the other embodiment of the present invention, wherein the discount rate has an upper-limit value;

FIG. 16 is a view illustrating the example of charged fee information of FIG. 13 in the other embodiment of the present invention; and

FIG. 17 is a view illustrating the construction of a general computer.

### DETAILED DESCRIPTION OF THE PREFERRED EMBODIMENTS

Hereinafter, an embodiment of the present invention will be explained with reference to the drawings.

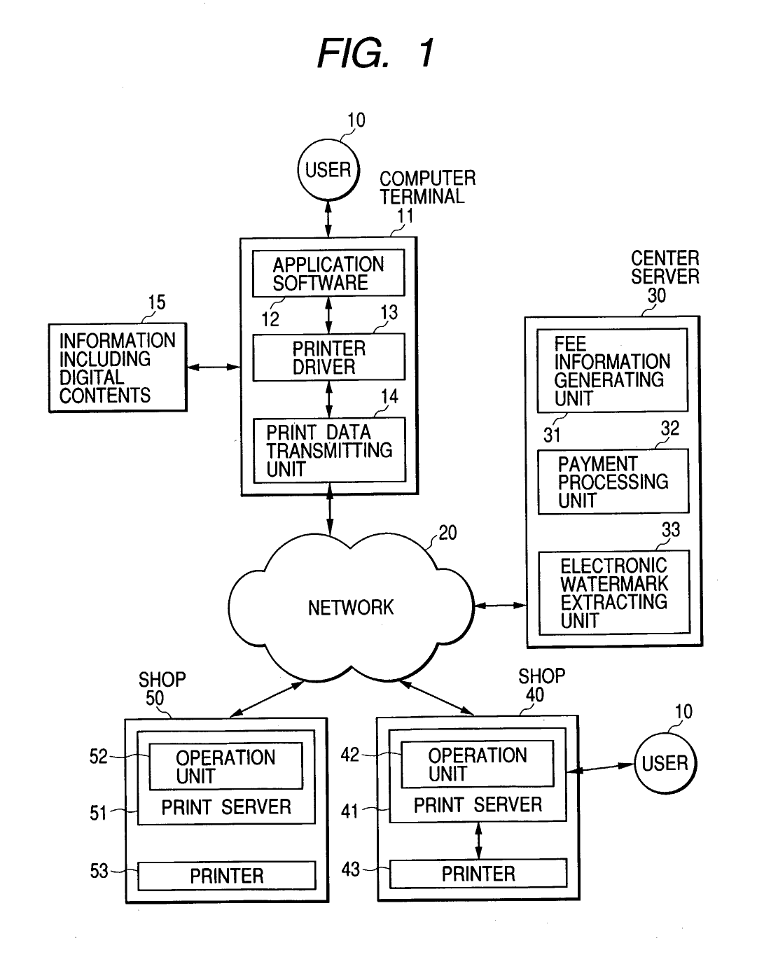

FIG. 1 illustrates a schematic construction of an entire print system, according to an embodiment of the present invention, which is constructed of a print control device (printer driver) as a data output control device, a center server that attains print data which has been transmitted from the data output control device by way of the Internet, transfers the print data to a print server as later described, and performs fee payment processing, and a print server that attains the print data which has been transmitted from the center server and a printing device (printer).

This public print system is comprised of constituent elements that will hereafter be explained. A reference numeral 10 denotes a customer (hereinafter, “the user”) who makes an order for printing, 11 denotes a computer terminal for making a print order, 20 denotes a network such as the Internet, 30 denotes a center server, 40 and 50 each denote a shop, 12 denotes an application that operates on the computer terminal 11, 13 denotes a printer driver that operates on the computer terminal 11, 14 denotes a print data transferring part that transmits to the center server 30 the print data that the printer driver has generated, 15 denotes information that contains therein digital contents for which the user wants to make a print order, 31 denotes a charged fee information generating part that analyzes the embedded information in the print data which has been transmitted on from the computer terminal and generates charged fee information containing discounting information, 32 denotes a fee payment processing part that carry out payment of a fee that is charged on printing, 33 denotes an electronic watermark extracting part that extracts electronic watermark information from the bit map data of the print data which has been transmitted on from the computer terminal, 41 denotes a print server that performs print control with respect to the information containing the digital contents therein for which an order for printing has been made, 42 denotes an operation part that operates the print server, and 43 denotes a printer that actually prints the digital contents. The print server 41, operation part 42, and printer 43 are provided within a shop 40, and, as indicated by a shop 50, there can be installed a plurality of shops each of that has a similar construction.

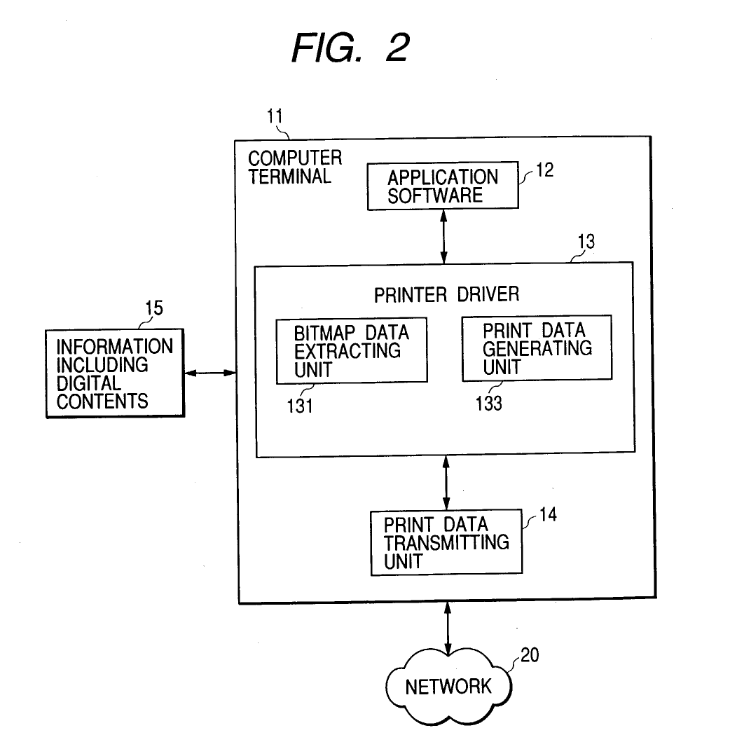

FIG. 2 is a view within which there is shown the construction of the computer terminal 11 in more detail than in FIG. 1. The computer terminal 11 reads in from the outside information containing digital contents therein such as that illustrated in FIG. 15 and has an application software 12 that has a function to process the information, etc. and a printer driver 13 that converts image data which has been produced by the application software 12 into print commands with respect to the printer 43.

The printer driver 13 has a bit map data extracting part 131 that extracts from within the information containing digital contents therein, produced by the application software 12, digital contents (bit map data) in which information might be embedded, and a print data generating part 133. The bit map data and print data that have been generated in that way are sent to the print data transfer part 14, and they are transmitted to the center server 30 by way of the network 20.

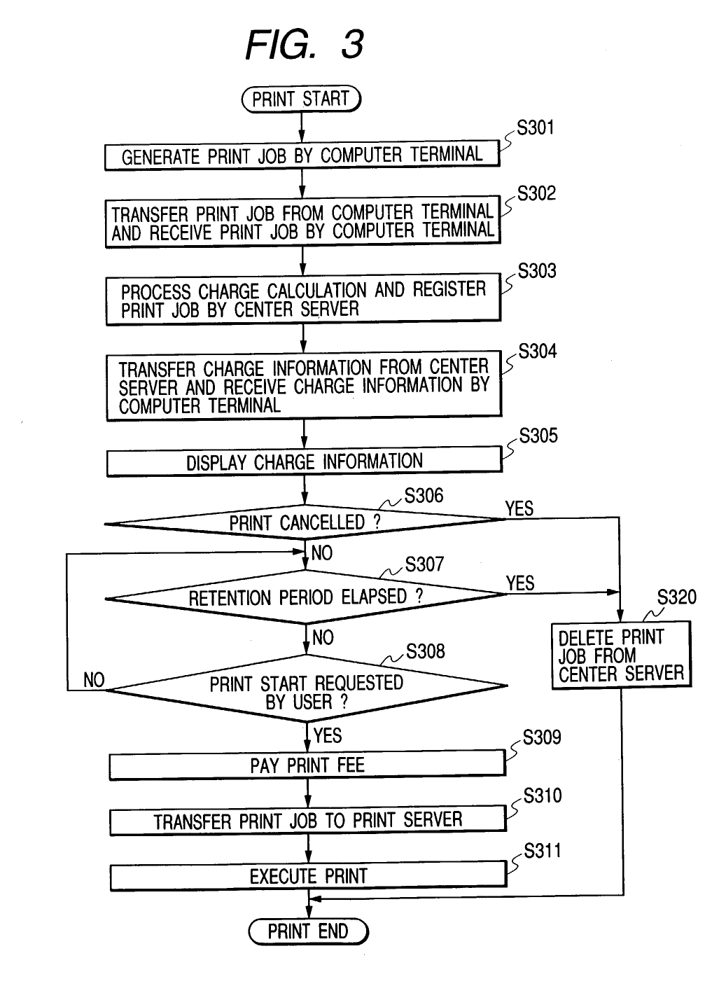

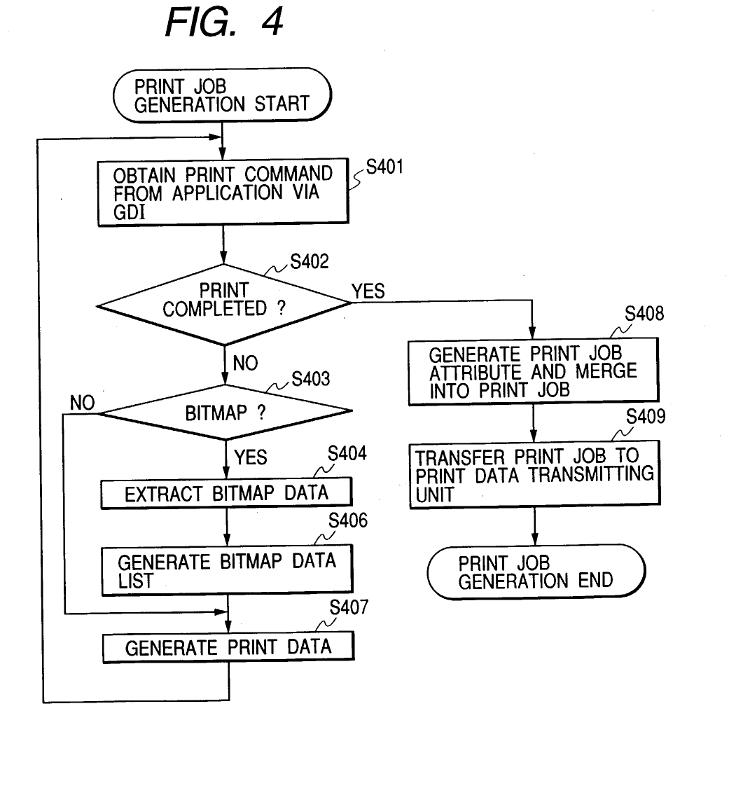

FIGS. 3 and 4 are flow charts illustrating the process flows according to the embodiment of the present invention. FIG. 3 illustrates the flow of the entire process from the start to the end of printing while FIG. 4 illustrates the detail of a print job generating process that is executed on the computer terminal 11.

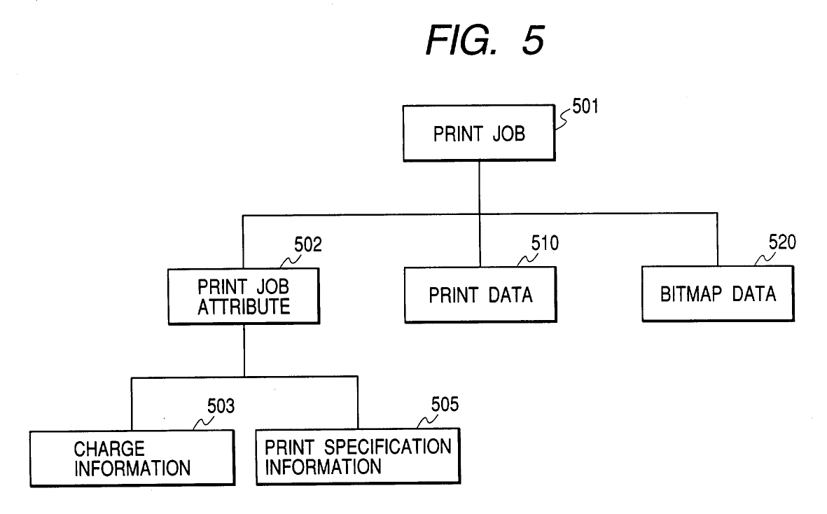

FIG. 5 is a view illustrating the construction of the print job that is generated by the printer driver 13. The print job that the print driver generates is constructed of print job attributes 502 including fee charging information 503, which is information that becomes needed for settlement of the print fee, and print specification information 505, actual print data 510, and bit map data 520 that is contained in the print data.

FIG. 6 illustrates an example of information containing digital contents therein that occurs in a case where the user 10 performs printing by using the present system. In this figure, portions 601 to 606 each of that is surrounded by an ellipse are examples of digital contents extracted by the electronic watermark extracting part as later described.

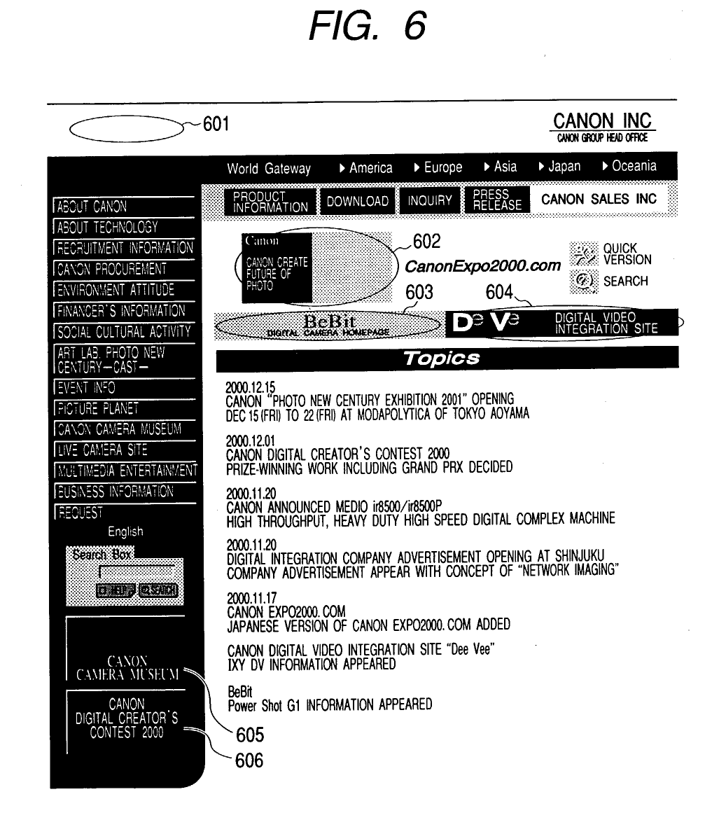

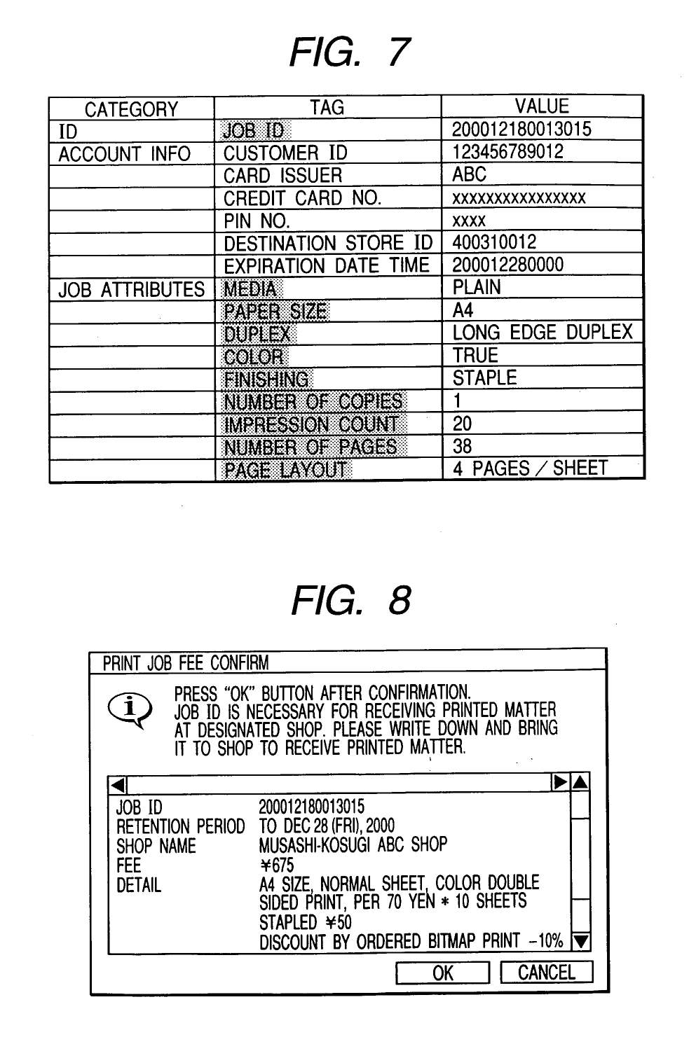

FIG. 7 illustrates a concrete example of the print job attributes 502 that are illustrated in FIG. 5.

FIG. 8 illustrates an example of a user interface for confirming the fee of the print job, which is displayed, with respect to the user 10, on the computer terminal.

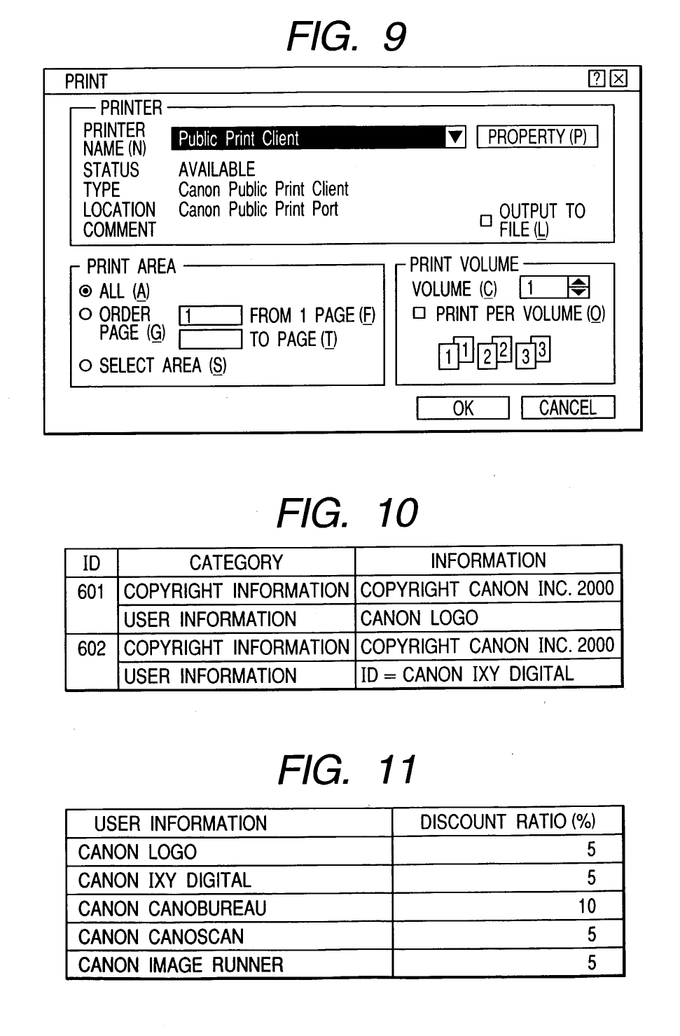

FIG. 9 illustrates an example of a user interface for selecting the printer driver 13 according to the present embodiment by the application software 12.

FIG. 10 illustrates an example of electronic watermark attribute information that is produced by the electronic watermark extracting part 33 of the center server 30.

FIG. 11 illustrates the kinds of the electronic watermarks and the information of discount ratios of the print fees that correspond to those electronic watermarks. Incidentally, the electronic watermarks and the information about the corresponding discount ratios are stored in the charged fee information generating part 31 of the center server 30.

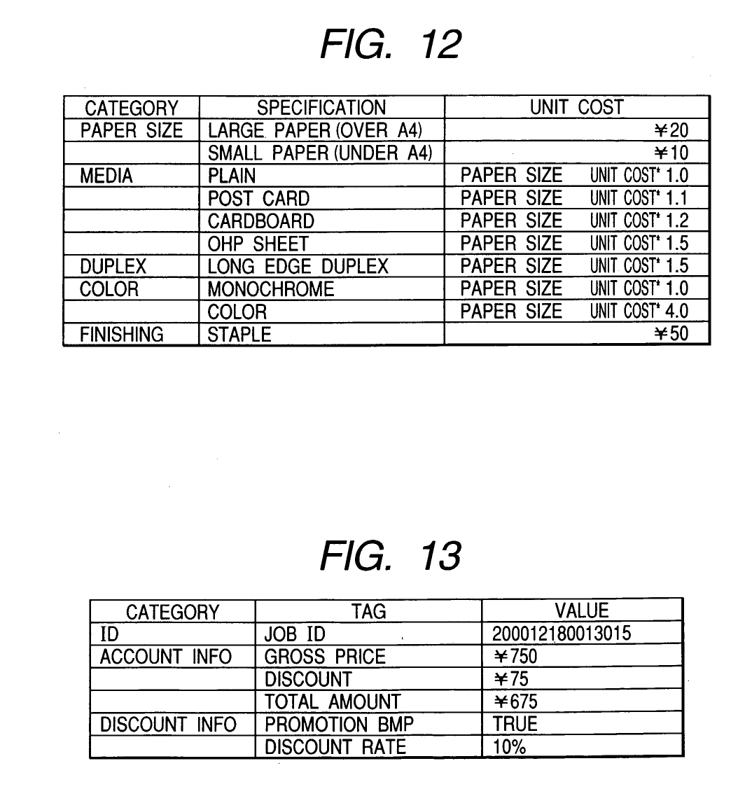

FIG. 12 illustrates information that is needed for calculating charged fee information. Those items of information are also stored in the fee charging information generating part 31 as in the case of the information that regards the discount ratio illustrated in FIG. 11.

FIG. 13 illustrates concrete examples of the charged fee information generated by the fee charging information generating part 31 of the center server 30.

In the following description, the detail of the present embodiment will sequentially be explained using the flow charts of FIGS. 3 and 4.

In FIG. 1, the user starts the application software 12 that operates on the computer terminal 11, and reads the information 15 containing digital contents therein into the application software 12 from a recording medium such as an FD (flexible disk), HD (hard disk), CD-ROM, DVD, etc., which are equipped to the computer terminal 11, or reads it thereinto from a Web server, etc. via the network, and performs working of information, editing thereof, and dialogue processing for making an order for printing. The order for printing that is made by the user is started by selecting the “Canon Public Print Client” in the view “Print dialogue” illustrated in FIG. 9 and clicking the “OK” button. By clicking the “OK” button, there is started the processing of S301 illustrated in FIG. 3 (the detailed processing steps thereof are illustrated in FIG. 4). However, the user, before doing that clicking, can click the “Property (P) - - - ” of FIG. 9 to open the user interface that the printer driver 13 displays and input user information (Customer ID, Credit card information, etc.) needed for making an order for printing (not illustrated). When printing process of the application software 12 is started by clicking the “OK” button, the application, according to the information containing digital contents therein, sequentially executes the printing process until the end of the printing operation by way of a print interface API (Application Program Interface) that the OS provides.

This process will now be explained using FIG. 4. The printer driver 13 receives via the print interface API that the OS provides a request to execute the printing process of the application software 12, and goes on executing the process. First, the printer driver gets an instruction to print from the application software 12 by way of a GDI (Graphics Device Interface) that is a part of the functions that the OS provides (S401). Next, the printer driver 13 determines whether the instruction that it has gotten is an instruction to end the printing (S402). As a result of the determination, the processing operations that are executed when the instruction is so will be described later. When the instruction is not a printing ending instruction, the printer driver 13 determines whether an instruction that it has received next is a bit map description instruction (S403). Determining whether the instruction is a bit map description instruction is possible with determining whether the printing instruction that the printer driver 13 has gotten is in connection with the description of a bit map. Specifically, whether the instruction is a bit map description instruction is determined depending on whether there has been called an I/F for processing a bit map, such as BitBlt, SetDIBitsToDevice, StretchBlt, StretchDIBits, etc., that the printer driver 13 prepares for the GDI. For example, in a case where information such as that illustrated in FIG. 6 has been ordered for printing, the portions that are surrounded in this figure by ellipses are printing-processed by the above-described kinds of bit map processing I/Fs. In a case where as a result of that determination the instruction has not been a bit map description instruction, the printer driver 13 produces (S407) print data corresponding to the instruction that the printer driver 13 has received, by the print data generating part 133 that is provided therein. Then the flow returns to the step S401. In a case where as a result of the determination the instruction has been a bit map description instruction, the printer driver saves as a bit map data list the bit map data that it has gotten via the GDI (S404, 406). Thereafter, the printer driver produces print jobs by the print data generating part 133 (S407), then the flow returns to the step S401. In this way, the printer driver repeatedly performs print data production, electronic-watermark detection, and attribute information production until it gets a print ending instruction. Although no particular illustration is made of the bit map data list that is produced in the step S406, this list may have a simple structure wherein the bit map data items that have been printed are in a connected form with one another.

Incidentally, although their process is not referred to in the description of this embodiment, the print job attributes 502 illustrated in FIG. 5 are produced. When roughly classified, the print job attributes that are produced are in a structural form illustrated in FIG. 5, and an example of the print job attributes is illustrated in FIG. 7. In the example illustrated in FIG. 7, information that is produced during the printing process is the one that is represented by those character strings in the column “Tag” that are highlighted. For example, there are JOB ID that is utilized for identifying corresponding print job until completion of the printing, and other items of information that include, as the print specification information 505, paper type (Media), paper size (Paper size), double-sided print (Duplex), finishing (Finishing), number of pages copied (Number of pages), number of surfaces printed (Impression Count), number of pages (Number of pages), and page layout (Page Layout).

In a case where, in the mid-course of the printing process, it has been determined in the step S402 that the instruction that has been input to the printer driver 13 is an instruction to finish printing, the printer driver 13 executes the print job attribute generation processing (S408). There, fee charging information 503 is produced. Of the fee charging information (Account Info) illustrated in FIG. 7, a customer ID (Customer ID), credit card company that is a fee-charging destination (Card Issuer), credit card number (Credit Card Number), code number (PIN number) information, and designated print destination store information (Destination Store ID), although not particularly illustrated in this embodiment, are input by the user 10 by way of the user interface that the printer driver 13 provides. The designated print destination store information is stored, as is, into an external storage device that is provided in the computer terminal while other information is stored in the form in which it is ciphered. In the step S408, the printer driver 13 reads out those items of information from the external storage device to thereby produce information. Information other than the designated print destination store information is set, on the fee charging information 503 as well, in the state of its being kept ciphered. Information regarding the deadline until which print job is retained (Expiration Date Time) is automatically produced so that the deadline may be the time 0:00 on the day that is ten days after the day on which a request to print was made. In the example illustrated in FIG. 7, there is illustrated a case where the day on which a request to print was made is Dec. 18, 2000 and the expiration date/time for retention of the print job is 0:00, Dec. 28, 2000. In addition, here, the bit map data 520 is produced from the bit map data list that has been produced in the step S406. And, the thus-produced print job attributes 502 and bit map data 520 are merged into the print job as part of the print job. Subsequently, that print job is transferred to the print data transferring part 14 (S409).

The print job generation process executed by the computer terminal of the step S301, which has been explained using FIG. 4, is complete upon end of all the above-described processing operations, then the processing flow proceeds to the transfer processing of the print job illustrated in FIG. 3 (S302). Here, by the print job transferring part 14, the print job is transmitted to the center server 30 via the network 20, and simultaneously the print job is received by the center server 30. Upon receipt of the print job by the center server 30, first, the bit map data 520 contained in the print job is searched by the electronic watermark extracting part of the center server, whereby the electronic watermark information contained therein is extracted. Here, the electronic watermarks that are detected in this embodiment are roughly classified into copyright information and user information as illustrated in FIG. 10. In the bit map data 520, there are contained all the bit maps extracted by six bit map description instructions issued with respect to the printer driver 13 and illustrated in FIG. 6. As a result of search of those bit maps, as illustrated in FIG. 10, electronic watermark attribute information is contained in each of the bit maps 601 and 602 and the contents thereof are as follows. In the bit map 601, the copyright information is “Copyright CANON INC. 2000” and the user information is “Canon Logo”. In the bit map 602, the copyright information is similarly “Copyright CANON INC. 2000” and the user information is “ID=Canon IXY Digital”. Incidentally, the ID in FIG. 10 is provided, for convenience of explanation, for clarifying the connection, with FIG. 6, of the explanation of this embodiment, in order to explain it. That ID, therefore, is not always needed when executing actual processing. Also, in the fee charging information generating part 31 of the center server, the calculation of the fee charged on that relevant printing is performed, and the print job is registered in the center server (S303). The fee charging information that regards the print fee is as illustrated in FIG. 13, and is associated with the print job by way of JOB ID and is managed by the center server. Actual fee charging information (the fee involving no discounting: Gross Price, the amount discounted: Discount, and the amount claimed: Total Amount) is calculated in accordance with the following procedures and is set.

First, the fee before discounted: Gross Price is calculated by the respective set values of the Media, Paper Size, Duplex, Color, Finishing, Number of Copies, Impression Count in the field “Job Attributes” and the fee-charging unit price table illustrated in FIG. 12.

Gross Price={Paper Size*(Media+Duplex+Color)*Impression Count/2+Finishing}*Number of Copies

={10*(1.0+1.5+4.0)*20/2+50}*=¥750

Amount Discounted: Discount is calculated using the electronic watermark attribute information (digital contents attribute information) in FIG. 7 that has been merged into the print job and the information representing the discount ratios of the print fees illustrated in FIG. 11. Regarding the rule according to which discounting is applied, in a case where among items of user information that exist in the electronic watermark attribute information there is an item of user information that coincides with the one in the items of user information within the print fee discount table, the discount ratio in FIG. 11 that is set in correspondence with the user information that has coincided is applied. Also, in a case where a plurality of electronic watermark attributes have coincided with the items of user information illustrated in FIG. 11, the discount ratio that is applied is defined as the sum total of the corresponding discount ratios. In this embodiment, as a result of the fact that the information illustrated in FIG. 6 has been printed, as illustrated in FIG. 7 two items of electronic watermark attribute information are generated. Comparing the user information “Canon Logo” and “Canon IXY Digital” of those two items of attribute information with the user information illustrated in FIG. 11, those items of user information which respectively coincide with each other are found out and it turns out that their respective discount ratios are Canon Logo=5% and Canon IXY Digital=5%. Accordingly, the discount ratios are calculated as follows.

Discount=Gross Price*(0.05+0.05)=750*0.10=¥75

Amount claimed: Total Amount is calculated according to the fee before discounting that was calculated in the above-described way: Gross Price and the amount discounted: Discount, as follows.

Total Amount=Gross Price−Discount=750−75=¥675

When the fee charging calculation processing has finished being done in the center server, the fee charging information is transmitted from the center server 30 to the computer terminal 11 via the network 20 and, simultaneously, the fee charging information is received by the computer terminal 11 (S304). In the computer terminal 11, upon its receipt of the fee charging information, as illustrated in FIG. 8, a dialogue view for asking the user 10 to confirm the print fee is displayed on a display, such as a CRT, connected to the computer terminal 11 (S305). As illustrated in FIG. 8, that dialogue sheet has two buttons “OK” and “Cancel”. The user can select either one of those buttons and click and execute corresponding processing. Which button has been clicked is determined in the subsequent step S306. Selecting the button “Cancel”, the printing processing is interrupted, the print job registered in the center server 30 is deleted (S320), and the printing processing becomes complete. On the other hand, in a case where having selected the button “OK”, the print job registered in the center server 30 continues to be print-processed.

The center server 30 keeps retaining the print job registered on the center server 30 until a request to print the print job that has been registered is issued to the center server 30 by the operation part 42 that the print server 41 installed in the shop 40 has, or until a retaining period of time lapses without receiving the request to print and the deadline has passed. The determination processing is repeatedly executed until either the condition of that the retaining period of time has lapsed (S307) or the condition of that the center server 30 has received a user 10's request to print from the operation part 42 (S308) is met. In a case where the retaining period of time has lapsed and the deadline has passed, the print job that was so far preserved on the center server 30 is deleted (S320) and the printing process becomes complete. In a case where having received the user 10's request to print, according to the fee charging information illustrated in FIGS. 7 and 15 print fee settlement processing is executed by the center server 30. In the case illustrated in this embodiment, the center server 30 charges a fee of 675 yen, with respect to the card company ABC, together with the user's card number xxxxxxx and the code number xxxxxxxx (S309). The fee charging transaction is promptly sent to a card company ABC's transaction server (not illustrated) via the network 20. Subsequently, the print job that had theretofore been preserved on the center server 30 is transferred to the print server 41 installed in the shop 40 (S310). The print server that has received the print job transmits the print data 510 to the printer 43 and performs printing thereof (S311). In this way, the user 10 goes to the shop 40 that he designated when having requested printing by his computer terminal 11, and, by inputting the JOB ID 200012180013015 illustrated in FIG. 7 from the operation part 42 of the print server 41 installed in the shop 40, receives the printed matter that he requested, from the printer 43.

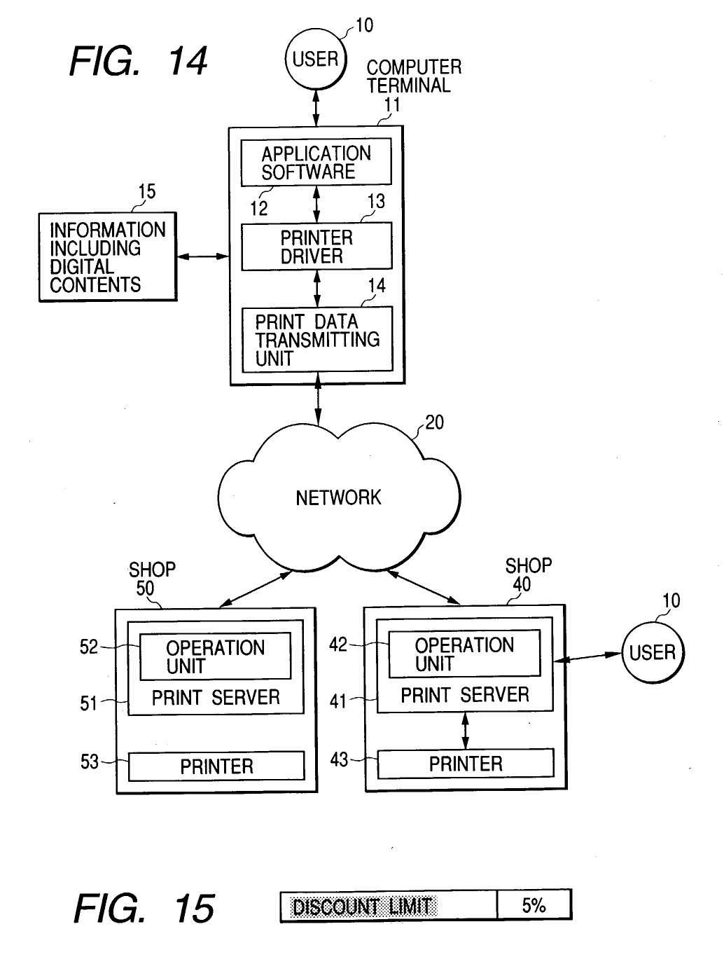

According to another embodiment, as illustrated in FIG. 14, the user may directly receive the print job by having access from the computer terminal 11 to the shop 40 via the network 20 without installing the center server 30 and the function of the center server 30 that was explained in the above-described embodiment may be provided on the print server 41 inside the shop.

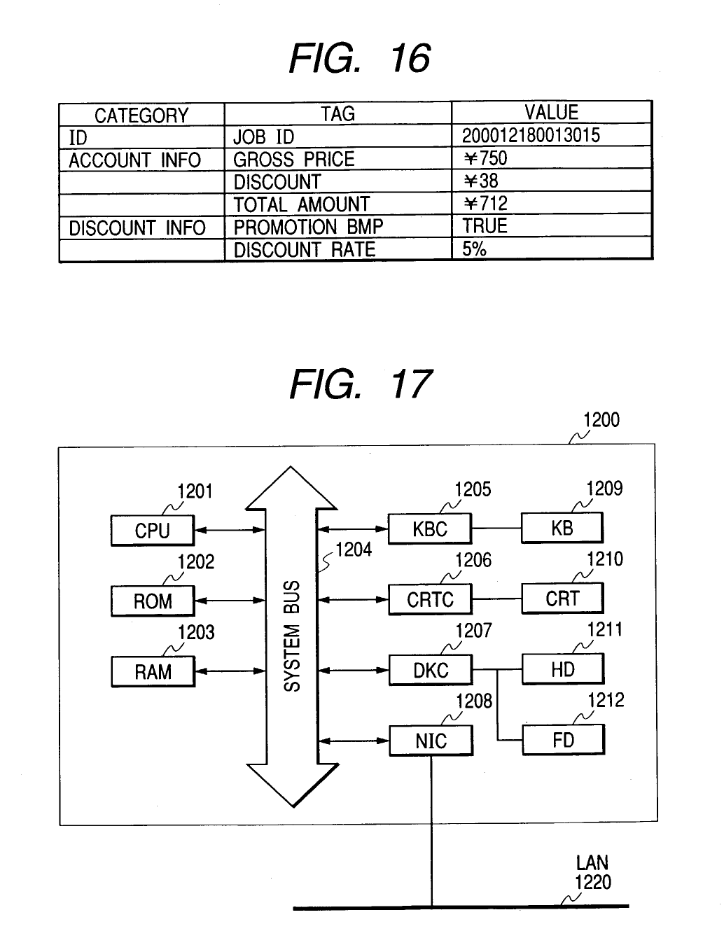

Also, according to another embodiment, as illustrated in FIG. 15, processing that performs calculation of the discount ratio according to the information that indicates the upper limit of the discount ratio may be added to the fee charging processing S303 illustrated in FIG. 3. In a case where as illustrated in FIG. 15 the upper limit of the discount ratio has been 5%, in the above-described embodiment there were two bit maps each of that was an object of discounting, and the discount ratios of that were 5% each. And the discount ratios the sum total of that was 10% were set in the field “Discount Rate”. However, in this embodiment, since in FIG. 15 the upper discount-ratio limit is set to be 5%, as illustrated in FIG. 16 the discount ratio in its Table has set therein 5%. Accordingly, the amounts of money that correspond to the Gross Price, Discount, and Total Amount are 5% each as illustrated in FIG. 16. Although among the items of information that show the discount ratios in FIG. 11 there is an entry of that the discount ratio of the Canon Canobureau is 10%, since in FIG. 15 the upper limit of the discount ratio is set to be 5%, even when in the information that the user has requested to print there is contained a bit map having the electronic watermark user information of Canon Canobureau, the print fee is not discounted.

Incidentally, although in the present invention the information embedded in the digital contents is handled as embedded information taking the form of electronic watermarks, in general tag information can be contained in image data, etc. and therefore the information may be handled as embedded information according to the present invention. Also, since the bit map data 520 contained in the print job is large in terms of the size, it may be contained in the print job after compressed in a format that can be developed on the center server.

<Other Embodiments>

Also, the present invention may be applied to a system constructed of a plurality of machines (for example, a host computer, interface device, reader, printer, etc.) or an apparatus consisting of a single piece of machine (for example, a copier, printer, or the like).

Also, in order that various kinds of devices may be operated with an aim to realize the functions of the above-described embodiment, the program code of the software for realizing the functions of the above-described embodiment may be supplied to a computer within an apparatus or system that has been connected to those kinds of devices. And by operating those kinds of devices according to the program stored in that computer (CPU or MPU) of that apparatus or system it is possible to embody the present invention. That apparatus or system also falls under the category of the present invention.

Also, in this case, the program code itself of the above-described software comes to realize the functions of the above-described embodiment and that program code itself constructs the present invention. As the transmission media of that program code there can be used communication media (wire lines such as optical fibers or wireless lines or the like) in a computer network (a LAN, a WAN such as the Internet, or wireless line) for supplying program information by propagating it as the carriers.

Further, means for supplying the above-described program code to the computer, for example a recording medium that has stored therein such program constructs the present invention. As the recording medium for storing the program code therein there can be used, for example, a flexible disk, hard disk, optical disk, magneto-optical disk, CD-ROM, magnetic tape, non-volatile memory card, or ROM.

In addition, by executing the program code supplied to the computer, the functions of the above-described embodiment are not only realized, but, even in a case where the functions of the above-described embodiment are realized in co-operation of that program code with the OS (Operating System) or other applications working on the computer, such program code is needless to say included under the category of an embodiment of the present invention.

Further, even in a case where the program code that has been supplied is stored in a memory equipped to a function extension board of the computer or a function extension unit connected to it and thereafter, according to the instructions of that program code, the CPU, etc. that is equipped to that function extension board or function extension unit executes a part, or the whole, of the actual processing operations and, by performing those processing operations, the functions of the above-described embodiment are realized, that program code is of course included under the category of the invention.

Also, it is quite a matter of course that the above-described computer may be a general personal computer such as that illustrated in FIG. 17. FIG. 17 is a view illustrating the internal construction of a general type of personal computer terminal.

In FIG. 17, 1200 denotes a computer PC. The PC 1200 is equipped with a CPU 1201 and executes a device control software that is stored in a ROM 1202 or hard disk (HD) 1211 or that is supplied from a flexible disk drive (FD) 1212 and performs general overall control of the respective devices connected to a system bus 1204.

By the program stored in the CPU 1201, ROM 1202 or hard disk (HD) 1211 of the PC 1200, the respective functions that are provided by the respective means of this embodiment are realized.

1203 is a RAM that functions as a main memory, work area, etc. for the CPU 1201. 1205 denotes a keyboard controller (KBC) that controls a command input from a keyboard (KB) 1209, or a device not illustrated, or the like.

1206 denotes a CRT controller (CRTC) that controls the display of a CRT display (CRT) 1210. 1207 denotes a disk controller (DKC) that controls access to the hard disk (HD) 1211 and a flexible disk (FD) 1212 that store therein a boot program (start program: a program for starting the execution (operation) of the hardware and software of the PC), a plurality of applications, an edit file, a user file, a network managing program, etc.

1208 denotes a network interface card (NIC) that performs bi-directional transmission/reception of data between it and a network printer, another network machine, or another PC, via a LAN 1220.

Incidentally, the configuration and structure of any one of the respective parts illustrated in the above-described embodiments are only illustrative of mere examples of embodiment that are embodied when embodying the present invention. The technical scope of the invention must never be construed as being limited by those examples of embodiment. Namely, the invention can be applied in various other modified or changed forms without departing from the spirit or principal features of the invention.

As has been explained above, according to the embodiment of the present invention, there has been provided a procedure of producing discount information according to the electronic watermark embedded in the digital contents and performing discount of the print fee in the print fee payment processing by using that discount information. By doing so, with respect to the user, there has been provided means for performing promotion that aims at enhancing the frequency of use of the public print. Simultaneously, there is also executed the discount processing wherein the public print system and the application enabling embedding of the electronic watermarks therein are combined. As a result of this, attaining the synergetic effect of making higher the frequency of use of the public print becomes able to be expected.

Also, if doing the fee charging calculation processing on the center server, regarding a change in the method of performing fee charging calculation, as well, such as new setting of the discount ratios it is only needed to modify the fee charging information generating part of the center server. In addition, since extraction of the electronic watermark attribute information is performed on the center server, by making the electronic watermark extracting part on the center server compatible with various methods of embedding the electronic watermarks, the invention can cope with the digital contents to which such various methods of embedding them are applied.

According to another embodiment, since the print job is directly transmitted to the relevant shop, there is also the effect that the time period needed when having instructed printing from the operation part becomes short, because the time period during which the relevant shop receives the print job from the center server can be saved.

Further, according to another embodiment, by setting an upper limit with respect to the discount ratios, even when requesting printing the information containing therein the bit maps containing therein a plurality of electronic watermarks that are objects of discounting, there is the effect that it becomes possible to prevent excessive discount from occurring and hence to prevent the print fee from being excessively decreased.

What is claimed is:

1. A public print system comprising:
a data output control device that includes:
means for generating from information containing digital contents output data that an output device provided in a shop can output;
means for extracting from the information those of the digital contents which can contain electronic watermarks;
means for transferring the output data and the extracted contents to a processing device that performs print-fee-charging calculation with respect to those output data and extracted contents that are set to fall under the category of a print job; and
means for attaining charged fee information from the processing device performing fee-charging calculation and displays it; and
a fee payment processing device that includes:
means for extracting from the extracted contents the information that has been embedded therein as electronic watermarks;
means for, according to the information that has been embedded, in a case where the information meets predetermined requirements, performing prescribed discounting with respect to the fee that is charged on the printing of the information containing digital contents; and
means for performing actual fee payment for the printing according to the discounting information by subtracting the discounting amount.

2. A public print system according to claim 1, further comprising an output device that attains embedded information from the output data and digital contents generated in the data output control device and executes fee charging calculation intended for discounting the price, executes print processing, and fee payment processing.

3. A public print system according to claim 1, further comprising a processing device for performing fee charge calculation, which includes means for setting an upper limit with respect to a discounting amount of money when performing fee charging calculation including discounting operations, according to the embedded information in the digital contents, and determining the discounting amount of money as being the one that corresponds to the upper limit when the discounting amount of money has exceeded the upper limit.

4. A public print service providing method comprising the steps of:
generating from information containing digital contents output data that an output device provided in a shop can output;
extracting from the information those of the digital contents which can contain electronic watermarks;
transferring the output data and the extracted contents to a processing device that performs print-fee-charging calculation with respect to those output data and extracted contents that are set to fall under the category of a print job;
attaining charged fee information from the processing device performing fee-charging calculation and displays it;
extracting from the extracted contents the information that has been embedded therein as electronic watermarks;
according to the extracted information that has been embedded, in a case where the information meets predetermined requirements, performing prescribed discounting with respect to the fee that is charged on the printing of the information containing digital contents; and
performing actual fee payment for the printing according to the discounting information by subtracting the discounting amount.

5. A public print service providing method according to claim 4, further comprising the step of attaining embedded information from the output data and digital contents and executing fee charging calculation intended for discounting the price, executing print processing, and fee payment processing.

6. A public print service providing method according to claim 4, further comprising the step of setting an upper limit with respect to a discounting amount of money when performing fee charging calculation including discounting operations, according to the embedded information in the digital contents and, determining the discounting amount of money as being the one that corresponds to the upper limit when the discounting amount of money has exceeded the upper limit.

7. A computer-readable storage medium having stored therein a program for causing the execution, by a computer, of the respective means included in the public print system according to claims 1 to 3 and the respective steps included in the public print service providing method according to claims 4 to 6.

8. A program for causing the execution, by a computer, of the respective means included in the public print system according to claims 1 to 3 and the respective steps included in the public print service providing method according to claims 4 to 6.
